(19) United States
(12) Patent Application Publication
(10) Pub. No.: US 2009/0013884 A1
(43) Pub. Date: Jan. 15, 2009

(54) SHEET PUNCHING AND EMBOSSING MACHINE AND METHOD FOR ORIENTING THE SHEETS

(75) Inventors: Michael PASUCH, Walldorf (DE); David EHRBAR, Walldorf (DE); Hendrik FRANK, Erkelenz (DE)

Correspondence Address: HEIDELBERGER DRUCKSMASCHINEN AKTIENGESELISCHAFT;C/O KEATING & BENNETT, LLP, 1800 Alexander Bell Drive, SUITE 200, Reston, VA, 20191, US

(73) Assignee: HEIDELBERGER DRUCKMASCHINEN AG, Heidelberg (DE)

(21) Appl. No.: 12/139,597

(22) Filed: Jun. 16, 2008

(30) Foreign Application Priority Data
Jul. 9, 2007 (DE) 10 2007 031 848.2

(51) Int. Cl. B41F 19/02; B65H 7/02

(52) U.S. Cl. 101/22; 271/228

(57) ABSTRACT

A method of orienting a sheet in a sheet punching and embossing machine and a sheet punching and embossing machine includes at least one processing station, a machine control system and a sheet transport system including circulating gripper carts with gripper bridges on which grippers are secured. The sheet is gripped and moved through the machine by the grippers. The sheet transport system includes circulating chains. The gripper carts include travel carts which are connected to the sheet transport system, and the gripper carts stop at a respective processing station to process the sheet. The gripper bridge of a gripper cart is connected by spring elements to the travel carts, and the gripper bridge includes a contact surface which can be brought into contact with at least one driven adjustment element of a respective processing station to orient the sheet in the processing station and to lower the gripper bridge into the processing stations.

### BACKGROUND OF THE INVENTION

1. Field of the Invention

The present invention relates to a sheet punching and embossing machine including circulating gripper bridges and a method for orienting sheets in the sheet punching and embossing machine.

2. Description of the Related Art

Punching refers to cutting with closed, geometrical forms, which can be circular, oval, or polygonal, as well as special shapes. Processes in the post processing of a print job, such as punching with a hollow punch, rounding corners, and register punching, are also included in this field. Punching is performed against a base or against a punch, and sometimes includes shearing processes. Packaging materials, such as paper, cardboard, paperboard or corrugated cardboard, are primarily punched in sheet format. During the punching process, however, groove lines or blind imprints may also be provided in the finished sheets. This complex process requires the sheets to be punched individually. Since the end products are packages with demanding technical and graphical requirements (such as those for cosmetics, cigarettes, medicines, foods, and other products), special requirements are imposed not only on the packaging materials themselves, but also on the punching machines and punching dies which must have minimal tolerances and must be extremely precise and reliable in order to obtain optimal results. These demands are best met by flat bed punches. The printed sheets, stacked on a pallet, are fed to the punch. In the machine, the sheets being punched are first oriented accurately in an orienting mechanism, picked up by a gripper cart and positioned precisely in the punching mechanism between a firmly mounted bottom table and a top table that moves vertically via a bent lever or eccentric gearing.

In known sheet punching and embossing machines, used for punching, waste-stripping, embossing and stacking of sheets of paper, cardboard, and other stock material, it is known how to move the sheets using gripper carts through the individual stations of the machine. Grippers are secured on the gripper carts and grab the sheets by a front end. The gripper carts are moved on endless chains through the machine. This type of movement of the sheets through the machine enables a continuous operation in the individual sequentially arranged stations of the machine.

Such a flat bed punch is disclosed, e.g., in DE 30 44 083 A1. The two tables are provided with cutting and grooving dies and corresponding counterplates, with which the finished copies are punched out from the sheets transported between the table surfaces in a timed cycle, and at the same time, the grooves required for a clean fold are indented in the sheets. In the subsequent waste stripping mechanism, the waste is mechanically removed via waste stripping dies. Finally, depending on the machine outfitting, the punched copies can be separated in a copy separation mechanism.

To achieve high product quality for the punched sheets, the sheet and dies must be oriented register-true to each other. In the punching station of a sheet punching and embossing machine, a punching die and a punching groove plate must be brought to an exact location in the perimeter direction and the lateral direction. Furthermore, both of the tools must be oriented perpendicular to the sheet transport direction without slanting. This reference position is referred to as “first blade.” In the following processing stations, the tools must be adjusted relative to the position of the first blade. For example, the waste stripping bed in the waste stripping unit and the copy separation screen in the copy separation station must be adjusted relative to the position of the first blade. Each of the tools must be adjusted in three degrees of freedom. During the operation of the sheet punching and embossing machine, it may be necessary to re-adjust the position of the tools in the punching station. The tools in the following processing stations must likewise be readjusted in order to bring them into the correct position relative to the first blade.

This cumbersome setup of the tools and dies ensures that the sheets are processed register-true. Here, the register describes the positional precision of the printed image with respect to the cutting, grooving and breakaway edges of the sheet. A distinction is drawn between perimeter register, i.e., the positional precision in the machine entry direction, and side register, i.e., the positional precision transverse to the machine entry direction.

A problem with the register-true orienting in the prior art is the fact that the large outfitting time, i.e., the amount of time spent on adjusting the tools and dies, significantly reduces the machine productivity.

Such gripper carts of sheet punching and embossing machines as described in the prior art are heavy, which limits the sheet transport speed.

To achieve high product quality for the punched sheets, the gripper bridges must be lowered into the processing stations.

EP 1 371 588 B1 describes a sheet punching and embossing machine with gripper carts fastened to circulating transport chains, which are oriented register-true in the peripheral direction by a positioning device defined by a swivel drive actuated by a servo-motor. In one embodiment of EP 1 371 588 B1, the swivel drive includes two separately actuated limit stops which enables a slanted orientation of the gripper cart. In another embodiment of EP 1 371 588 B1, the position of the positioning device can be changed by servo-motors, and thus, the gripper cart can be individually oriented.

The problem with the prior art sheet punching and embossing machines is that high register quality, i.e., an exact register orientation, requires a high chain tension. The high chain tension causes a heavy strain on the components, which must be designed and dimensioned accordingly. Chain lengthening must be prevented and compensated for. Another problem is that register orientation and lowering of the gripper cart into the processing stations is performed by separate subassemblies.

### SUMMARY OF THE INVENTION

To overcome the problems described above, preferred embodiments of the present invention provide a method for sheet orientation and a sheet punching and embossing machine including gripper carts enabling a high level of machine productivity, along with simultaneously high product quality.

A method for sheet orientation by a sheet punching and embossing machine according to a preferred embodiment of the present invention includes gripper carts having a low weight and enabling a shorter machine setup time due to a simple orientation of the sheet in a peripheral direction.

A sheet punching and embossing machine according to a preferred embodiment of the present invention includes at least one processing station. The processing station may be a punching station, waste stripping station, or copy separation station. The sheet punching and embossing machine also includes a sheet transport system and a machine control system arranged to actuate the sheet transport system and the processing stations. The sheet transport system includes circulating gripper carts with gripper bridges. Grippers which grip the sheets by a gripping edge and move them through the machine from one station to another are fastened on the gripper bridges. The gripper carts are stopped at a particular processing station for the processing of a respective sheet. Each gripper cart includes in the direction of sheet transport, right and left travel carts, which are fastened to a circulating chain. The gripper bridge of a particular gripper cart is connected by a spring element to the travel carts. The spring elements are configured such that the gripper bridge can be moved to further orient the sheet in the processing stations and/or to lower the gripper bridge into the processing stations. The gripper bridge of a gripper cart includes a contact surface which can be brought into contact with an adjustment element provided in a particular processing station. Alternatively, several adjustment elements may be provided in a processing station. Each of the adjustment elements includes a drive unit. In one preferred embodiment of the sheet punching and embossing machine, the adjustment element can transmit forces in the direction of sheet transport and in a direction opposite to the direction of sheet transport onto the respective contact surface of a particular gripper bridge. As a result, the gripper bridge is arranged in the peripheral direction.

In another preferred embodiment of the sheet punching and embossing machine, the adjustment element can transmit forces in a substantially vertical direction onto the respective contact surface of a particular gripper bridge. As a result, the gripper bridge is lowered.

In another preferred embodiment of the sheet punching and embossing machine, the transmission of force by the adjustment element to the contact surface occurs by friction. The adjustment element may be a pressure roller which rotates about its axis and can be lowered substantially perpendicular to the axis.

In an alternative preferred embodiment of the sheet punching and embossing machine, the transmission of force from the adjustment element to contact surface occurs by form closure.

In a preferred embodiment of the sheet punching and embossing machine, the spring elements are defined by spring steel sheets and sliding links with spiral springs. The spiral springs preferably have a progressive characteristic. This ensures that only one force needs to be applied for a slight deflection of the sliding linkage.

In a preferred embodiment of the sheet punching and embossing machine, the machine includes at least one sensor at each processing station arranged to determine the position of the sheet. The configuration of the sensors is dependent upon on the application.

Furthermore, the sheet punching and embossing machine preferably includes a measurement system arranged to measure the position of the sheet upstream from the first processing station. This measurement system provides necessary information for a side orienting of the sheet. In order to position and lower the gripper bridges register-true, in a preferred embodiment of the sheet punching and embossing machine, the drive units of the adjustment elements and the sensors of a respective processing station are components of a respective feedback control circuit. Each processing station includes a feedback control circuit. The measurement system located upstream from the first processing station arranged to determine the position of the sheet may preferably be integrated in the feedback control circuit of the first processing station.

Another preferred embodiment of the present invention provides a method for orienting the sheets in processing stations for sheets of paper, cardboard, and other stock material, which are transported with gripper carts through a sheet processing machine. The sheet processing machine is preferably a sheet punching and embossing machine. During the transfer of a sheet from the sheet feeder to a gripper cart, the actual position of the sheet is determined by known systems, such as noncontact sensors and cameras, for example. The gripper carts include grippers that are arranged to grip the sheet and are driven by chains to transport a particular sheet into a processing station. As soon as a sheet is in a processing station, the drive unit of the sheet transport system is stopped and an adjustment element is lowered until it is in contact with a contact surface of a gripper bridge. At the processing station, the actual position of the sheet is compared to a desired position. Here as well, known systems for detecting an article, i.e., detecting the position of the sheet, are used, such as sensors and cameras, for example. Depending on the result of the comparison, the gripper bridges of a gripper cart will be register-oriented in the peripheral direction by the transmission of force by the driven adjustment element onto the contact surface of the gripper bridge, so that the sheet itself is peripherally oriented. The side register orientation, i.e., the register-true orienting of the gripper cart substantially perpendicular to the direction of sheet transport, may be performed by an additional mechanical adjustment device. The necessary adjustment distances are determined either by an additional article detection systems located in a particular processing station, such as sensors, for example, or by a system located upstream from the first processing station.

It is preferable to trigger the lowering of the gripper bridge subsequently in the processing stations by transmission of force from a driven adjustment element to a contact surface of the gripper bridge. After the sheet orientation described above, the sheet is processed in a subsequent step.

As an alternative to determining the actual position of the sheet upon transfer of a sheet from the sheet feeder to a particular gripper cart, it is also possible to survey the actual position of the sheet upstream from each processing station.

Other features, elements, processes, steps, characteristics and advantages of the present invention will become more apparent from the following detailed description of preferred embodiments of the present invention with reference to the attached drawings.

### BRIEF DESCRIPTION OF PREFERRED EMBODIMENTS

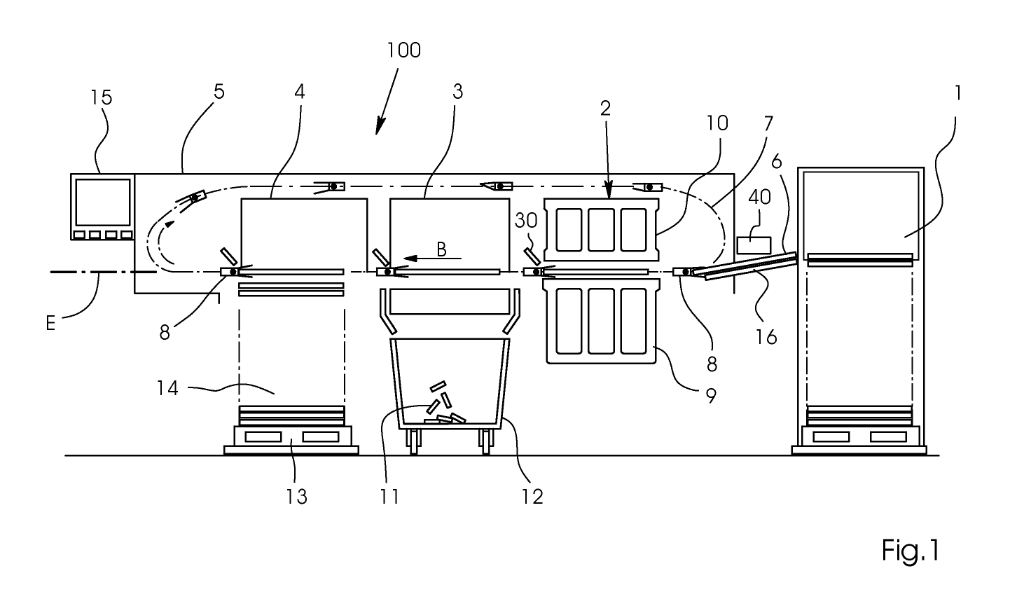

FIG. 1 shows a sheet punching and embossing machine according to a preferred embodiment of the present invention.

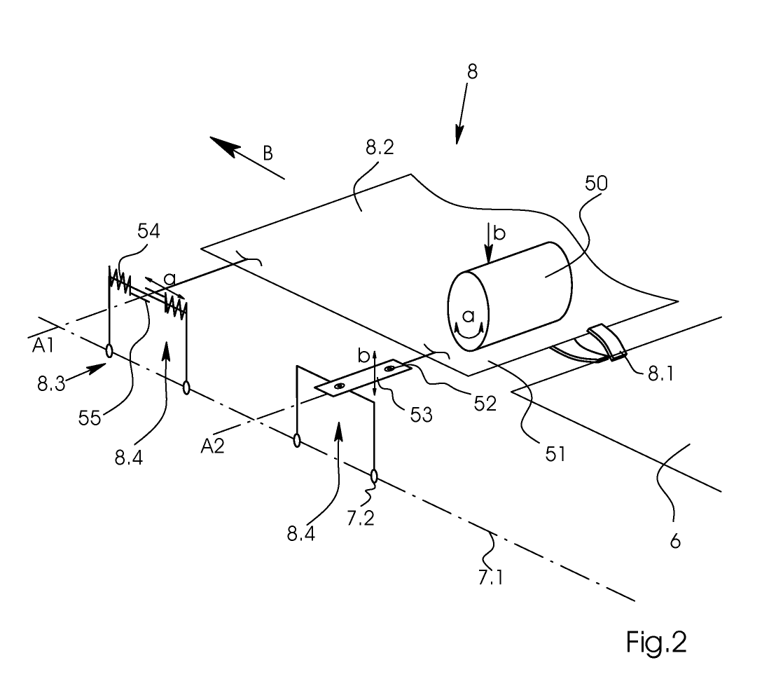

FIG. 2 shows an adjustment element in contact with a gripper cart according to a preferred embodiment of the present invention.

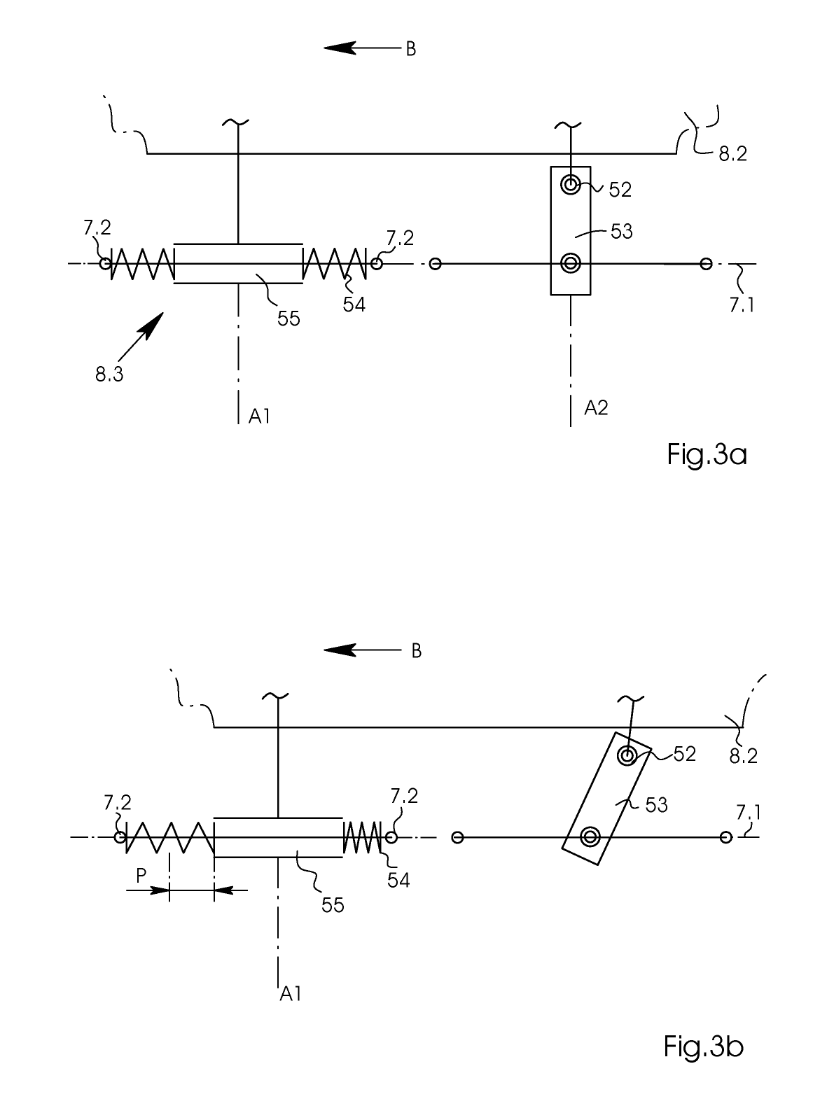

FIG. 3a shows a top view of a segment of a gripper cart which is not oriented.

FIG. 3b shows a top view of a segment of an oriented gripper cart.

### DETAILED DESCRIPTION OF PREFERRED EMBODIMENTS

FIG. 1 shows the basic layout of a sheet punching and embossing machine 100 for the punching, waste-stripping and delivery of sheets of paper, cardboard, or other stock material according to a preferred embodiment of the present invention. The punching and embossing machine 100 includes an input device 1, a punching station 2, a waste stripping station 3, and a delivery unit 4, which are disposed a common machine housing 5.

The sheets 6 are individually removed from a stack by a feeder 1, fed to the sheet transport system 7 including circulating chains, and gripped at their front edge by grippers fastened to gripper carts 8 including gripper bridges and intermittently pulled in the sheet delivery direction B through the various stations 2, 3, and 4 of the punching and embossing machine 100. The gripper bridges of a gripper cart 8 are connected by spring elements to the travel cart (not shown).

In the vicinity of the feed table 16 between the feeder 1 and the punching station 2, a measuring system 40 is arranged to determine the position of the sheet 6.

The punching station 2 includes a bottom table 9 and a top table 10. The bottom table 9 is fixedly mounted in the machine frame and provided with a counterplate for the punching blade. The top table 10 is mounted so as to be movable upwardly and downwardly.

The gripper cart 8 transports the sheet 6 from the punching and embossing machine 2 to the following waste stripping station 3, which includes waste stripping dies. At the waste stripping station 3, the unneeded waste pieces from the sheet 6 are pushed downward by the waste stripping dies, so that the waste pieces 11 drop into a bin-like cart 12 disposed underneath the station.

From the waste stripping station 3, the sheet 6 is transported to the delivery unit 4, where the sheet 6 is either stacked, or is separated into individual copy units. The delivery unit 4 may include a pallet 13 on which the individual sheets 6 are disposed in a stack 14, so that after reaching a certain stack height, the pallets 14 with the stacked sheets 6 can be transported away from the punching and embossing machine 100 along a transport path E.

At the respective processing stations 2, 3, 4 sensors 30 are provided which detect the exact position of a sheet 6 by detecting its edges. The values detected by the sensors 30 are transmitted for evaluation to the machine control system 15.

FIG. 2 shows an adjustment element, here a pressure roller 50, in contact with a gripper cart 8. The gripper cart 8 includes a gripper bridge 8.2 including grippers 8.1 and travel carts 8.3. The grippers 8.1 are fastened on the gripper bridge 8.2 in order to grip a sheet 6. The gripper bridge 8.2 is provided with a friction plate 5 1. With the friction plate 51, the pressure roller 50 is in contact with the gripper bridge 8.2. The gripper bridge 8.2 is connected via several travel carts 8.3 to the chain 7.1 of the transport system 7 (not shown in FIG. 2). The travel carts 8.3 are fastened in the chain bolts 7.2 of the chain 7. 1. The fastening of the gripper bridge 8.2 to the travel carts 8.3 is provided via spring elements 8.4. Two different types of spring elements 8.4 are used in the present preferred embodiment. The position of the spring element 8.4 is defined by two axes A1 and A2, with the two axes lying substantially parallel to each other and at right angles to the direction of sheet transport B. The spring element 8.4, which is located on the axis A1, includes a sliding link 55 with two spiral springs 54 and allows movement of the gripper bridge 8.2 in the direction a and thereby enables the register orientation in the peripheral direction. The spring element 8.4, which is located in axis A2, includes a spring steel sheet 53 with links 52. The links 52 allow a twisting of the spring steel plate 53 in the plane defined by axes A1 and A2. Furthermore, the spring steel sheet 53 can be deflected substantially perpendicular to this plane in the direction b by bending. Due to this deflection of the spring steel sheet 53, it is possible to lower the gripper cart.

The register orientation a in the peripheral direction and the lowering of the gripper cart b are performed by corresponding movements of the pressure roller 50. Due to the friction pair including the pressure roller 50 and the friction plate 51, a rotation of the pressure roller 50 produces a displacement of the gripper bridge 8.2 in or opposite to the direction of sheet transport B. This displacement is used for the register orientation a in the peripheral direction and it is enabled by the combination of spring elements 8.4. If the pressure roller 50 is lowered, this movement is transmitted by the friction plate 51 to the gripper bridge 8.2. The lowering of the gripper cart b is enabled by the bending of the spring steel sheet 53.

The register orientation is shown in detail in FIGS. 3a and 3b. FIG. 3a shows the situation of a gripper bridge 8.2 not yet register-oriented. The links 52 of the spring element 53 lie on the axis A2. The deformation of the two spiral springs 54 is substantially the same and the sliding link 55 lies midway between the two chain bolts 7.2, by which the travel cart 8.3 is secured to the chain 7.1. FIG. 3b shows the situation of a gripper bridge 8.2 in the register-oriented condition. The gripper bridge 8.2 has been displaced by the register P relative to the chain 7.1 and the chain bolts 7.2 in a direction opposite to the direction of sheet transport B. The spiral springs 54 are unequally strained and the spring steel sheet 53 is twisted.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A sheet punching and embossing machine comprising:
at least one processing station;
a machine control system; and
a sheet transport system including a circulating chain, gripper carts attached to the circulating chain, each of the gripper carts including at least one gripper bridge, and at least one gripper attached to each of the gripper bridges, the at least one gripper being arranged to grip and move sheets through the sheet punching and embossing machine; wherein
each of the gripper carts includes at least one travel cart which is connected to the circulating chain;
the gripper carts stop at the at least one processing station to enable processing of one of the sheets;
the at least one processing station includes at least one adjustment element;
the at least one gripper bridge of a respective one of the gripper carts is connected by at least one spring element to the at least one travel cart;
the at least one gripper bridge includes a contact surface arranged to be brought into contact with the at least one adjustment element; and
the at least one adjustment element includes a drive unit arranged to orient the one of the sheets in the at least one processing station and to lower the at least one gripper bridge into the at least one processing station.

2. The sheet punching and embossing machine according to claim 1, wherein the at least one adjustment element is arranged to transmit forces in a direction of sheet transport and in a direction opposite to the direction of sheet transport onto the contact surface of the at least one gripper bridge to adjust a peripheral orientation of the at least one gripper bridge.

3. The sheet punching and embossing machine according to claim 1, wherein the at least one adjustment element is arranged to transmit forces in an upward and downward direction onto the contact surface of the at least one gripper bridge to lower the at least one gripper bridge.

4. The sheet punching and embossing machine according to claim 2, the forces transmitted by the at least one adjustment element onto the contact surface is provided by friction.

5. The sheet punching and embossing machine according to claim 4, wherein the at least one adjustment element is a pressure roller.

6. The sheet punching and embossing machine according to claim 2, wherein the forces transmitted by the at least one adjustment element onto the contact surface is provided by form closure.

7. The sheet punching and embossing machine according to claim 1, wherein the at least one spring element is one of a spring steel sheet and a sliding link including spiral springs.

8. The sheet punching and embossing machine according to claim 1, wherein the sheet punching and embossing machine includes at least one sensor at each of the at least one processing station arranged to determine a position of the sheet.

9. The sheet punching and embossing machine according to claim 1, wherein the sheet punching and embossing machine includes a measurement system arranged to measure a position of the sheet upstream from a first processing station of the at least one processing station.

10. The sheet punching and embossing machine according to claim 8, wherein at least the drive unit of the at least one adjustment element and the at least one sensor are components of a feedback control circuit for register-true positioning and lowering of the gripper bridges.

11. A method for orienting sheets in processing stations transported by gripper carts through a sheet processing machine, the method comprising the steps of:
transferring a sheet from a sheet feeder to a gripper cart;
transporting a gripper cart to a processing station and stopping the gripper cart;
comparing an actual position of the sheet to a desired position of the sheet in the processing station using a measurement system;
register-true orienting a sheet holding position of a gripper bridge of the gripper cart in a peripheral direction of the sheet by transmitting force from a driven adjustment element to a contact surface of the gripper bridge; and
lowering the gripper bridge of the gripper cart in the sheet holding position by transmitting force from the driven adjustment element to the contact surface of the gripper bridge.

12. The method according to claim 11, further comprising the steps of:
determining the actual position of the sheet when the sheet is transferred from the sheet feeder to the gripper cart using the measurement system;
side-orienting the gripper bridge using a mechanical device.
